(19) United States
(12) Patent Application Publication
(10) Pub. No.: US 2025/0046100 A1
(43) Pub. Date: Feb. 6, 2025

(54) PARKING LOT DETERMINATION DEVICE, CONTROL DEVICE FOR VEHICLE, AND PARKING LOT DETERMINATION METHOD

(71) Applicants: TOYOTA JIDOSHA KABUSHIKI KAISHA, Toyota-shi (JP); DENSO CORPORATION, Kariya-city (JP)

(72) Inventors: Naoya MATSUNAGA, Nagoya-shi (JP); Takuya KAMINADE, Okazaki-shi (JP); Masaki IKAI, Toyota-shi (JP); Ryo ISHII, Toyota-shi (JP); Masashi OISHI, Owariasahi-shi (JP)

(73) Assignees: TOYOTA JIDOSHA KABUSHIKI KAISHA, Toyota-shi (JP); DENSO CORPORATION, Kariya-city (JP)

(21) Appl. No.: 18/763,266

(22) Filed: Jul. 3, 2024

(30) Foreign Application Priority Data
Jul. 31, 2023 (JP) 2023-124593

(51) Int. Cl. G06V 20/58; B60W 30/14

(52) U.S. Cl. CPC G06V 20/586; B60W 30/146

(57) ABSTRACT

To effectively determine that a vehicle is traveling a parking lot, provided is a parking lot determination device for recognizing, based on image data acquired by capturing a periphery of a vehicle, a parking space and/or a parked vehicle in the periphery of the vehicle, and determining that the vehicle is traveling in a parking lot when a determination condition that a predetermined number or more of adjacent parking spaces and/or adjacent parked vehicles are recognized is satisfied, wherein the predetermined number to be used for the determination condition is reduced when a predetermined specific parking space is included in at least one or more parking spaces recognized based on the image data compared with the predetermined number to be used when the specific parking space is not included.

### BACKGROUND OF THE INVENTION

### 1. Field of the Invention

The present disclosure relates to a parking lot determination device, a control device for a vehicle, and a parking lot determination method.

### 2. Description of the Related Art

For example, in Japanese Patent No. 6299179, there is disclosed a device which recognizes a parking space in front of a vehicle based on road marking lines in front of the vehicle captured by an in-vehicle camera, and enables driving force suppression control caused by an accelerator erroneous operation of a driver to be more easily activated when the parking space is recognized than when the parking space is not recognized.

In order to appropriately activate the driving force suppression control caused by the accelerator erroneous operation of the driver in a parking lot, it is desired that a recognition accuracy of the parking space be increased, to thereby effectively determine that the vehicle is traveling in the parking lot.

### SUMMARY OF THE INVENTION

The present disclosure has been made in order to solve the above-mentioned problem. That is, one object of the present disclosure is to effectively determine that a vehicle is traveling in a parking lot.

According to at least one embodiment of the present disclosure, there is provided a parking lot determination device for recognizing, based on image data acquired by capturing a periphery of a vehicle, a parking space and/or a parked vehicle in the periphery of the vehicle, and determining that the vehicle is traveling in a parking lot when a determination condition that a predetermined number or more of adjacent parking spaces and/or adjacent parked vehicles are recognized is satisfied, wherein the predetermined number to be used for the determination condition is reduced when a predetermined specific parking space is included in at least one or more parking spaces recognized based on the image data compared with the predetermined number to be used when the predetermined specific parking space is not included.

With the above-mentioned configuration, the parking lot determination device relaxes the condition for the parking lot determination when, in the parking spaces and/or parked vehicles recognized as adjacent, at least one or more specific parking spaces are included in the parking spaces. As a result, it is possible to prevent the condition for the parking lot determination from becoming unnecessarily strict, and hence it is possible to effectively determine whether or not the vehicle is traveling in the parking lot.

### BRIEF DESCRIPTION OF THE DRAWINGS

FIG. 1 is a schematic overall configuration diagram of a parking lot determination device according to at least one embodiment of the present invention.

FIG. 2 is a schematic view of partition lines and a parked vehicle in a parking lot as viewed from above.

FIG. 3A, FIG. 3B, and FIG. 3C are schematic views for illustrating examples of specific parking spaces each having a drawn specific mark.

FIG. 4A, FIG. 4B, and FIG. 4C are schematic views for illustrating determination of a parking row.

FIG. 5 is a flowchart for illustrating a routine of processing for intra-parking lot determination, accelerator erroneous operation determination, and driving force suppression control.

FIG. 6 is a schematic view for illustrating a modification example.

### DESCRIPTION OF THE EMBODIMENTS

Description is now given of a parking lot determination device, a control device for a vehicle, and a parking lot determination method according to at least one embodiment of the present disclosure with reference to the drawings.

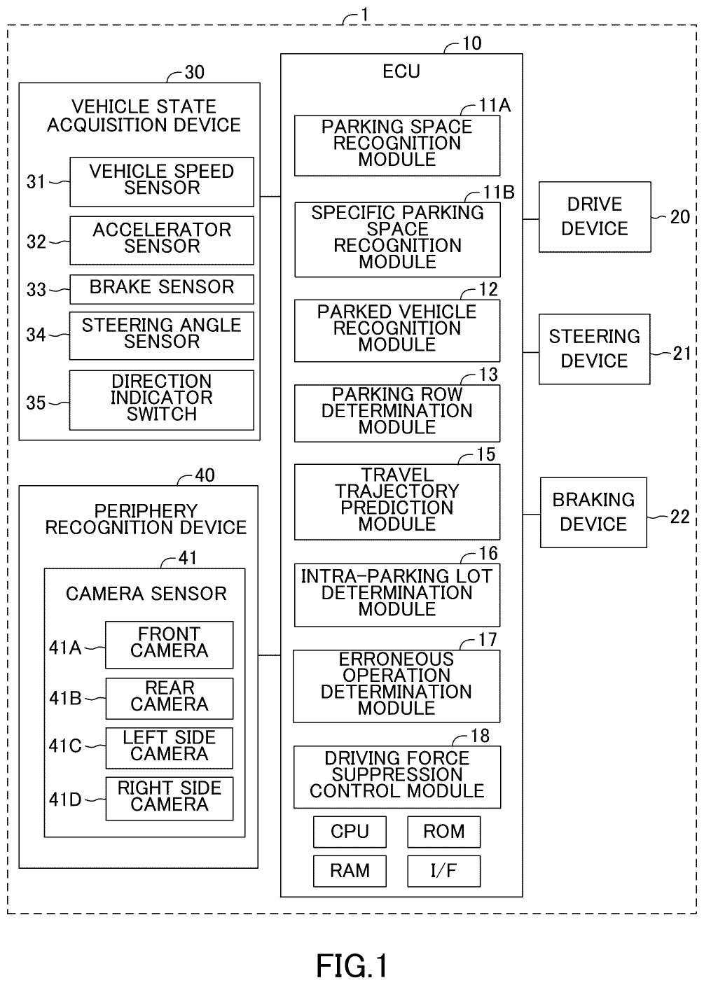

FIG. 1 is a schematic overall configuration diagram of a vehicle 1 in the at least one embodiment. The vehicle 1 includes an electronic control unit (ECU) 10. The ECU 10 includes a central processing unit (CPU), a read only memory (ROM), a random access memory (RAM), an interface device, and the like. The CPU executes various programs stored in the ROM. The ROM is a nonvolatile memory, and stores data required for the CPU to execute the various programs. The RAM is a volatile memory, and provides a work area in which the various programs are loaded when the various programs are to be executed by the CPU. The interface device is a communication device for communicating to and from an external device.

The ECU 10 is a central control device which executes driving assistance for a driver and the like. The driving assistance is a concept including self-driving. To the ECU 10, a drive device 20, a steering device 21, a braking device 22, a vehicle state acquisition device 30, a periphery recognition device 40, and the like are connected for communication.

The drive device 20 generates a driving force to be transmitted to driving wheels of the vehicle 1. As the drive device 20, for example, an electric motor and an engine are given. The steering device 21 applies a turning force to the wheels of the vehicle 1. The braking device 22 applies a braking force to the wheels of the vehicle 1.

The vehicle state acquisition device 30 is sensors which acquire states of the vehicle 1. The vehicle state acquisition device 30 specifically includes a vehicle speed sensor 31, an accelerator sensor 32, a brake sensor 33, a steering angle sensor 34, a direction indicator switch 35, and the like.

The vehicle speed sensor 31 detects a travel speed (vehicle speed V) of the vehicle 1. The accelerator sensor 32 detects an operation amount of an accelerator pedal (accelerator) (not shown) by a driver. The brake sensor 33 detects an operation amount of a brake pedal (not shown) by the driver. The steering angle sensor 34 detects a steering angle of a steering wheel (or a steering shaft) (not shown). The direction indicator switch 35 detects an operation of a direction indicator lever (not shown) by the driver. The vehicle state acquisition device 30 transmits, at a predetermined cycle, a state of the vehicle 1 detected by each of the sensors 31 to 35 to the ECU 10.

The periphery recognition device 40 is sensors which acquire target information on targets in the periphery of the vehicle 1. Specifically, the periphery recognition device 40 includes a camera sensor 41. Examples of the target information include a peripheral vehicle, a peripheral building, an intersection, a traffic light, a traffic sign, a partition line of a parking lot, and a white line, a stop line, and a mandatory stop line of a road. The target information on the periphery of the vehicle 1 acquired by the periphery recognition device 40 is transmitted to the ECU 10.

The camera sensor 41 captures the periphery of the vehicle 1, and processes captured image data, to thereby acquire an image of the periphery of the vehicle 1. The camera sensor 41 is, for example, a stereo camera or a monocular camera, and a digital camera including an image pickup element such as a CMOS device or a CCD can be used. In the at least one embodiment, the camera sensor 41 includes a front camera 41A which captures a front region of the vehicle 1, a rear camera 41B which captures a rear region of the vehicle 1, a left side camera 41C which captures a left side region of the vehicle 1, and a right side camera 41D which captures a right side region of the vehicle 1. The plurality of cameras 41A to 41D are hereinafter simply referred to as “camera sensor 41.” Moreover, the image data captured by the cameras 41A to 41D is collectively referred to as “image data.”

A software configuration of the ECU 10 is now described. The ECU 10 includes, as a part of function elements, a parking space recognition module 11A, a specific parking space recognition module 11B, a parked vehicle recognition module 12, a parking row determination module 13, a travel trajectory prediction module 15, an intra-parking lot determination module 16, an erroneous operation determination module 17, and a driving force suppression control module 18. Those function elements are described as being included in the ECU 10 which is integrated hardware, but any part thereof may be provided to an ECU independent of the ECU 10. Moreover, all or a part of the function elements of the ECU 10 may be provided to an information processing device of a facility (for example, a management center) communicable to and from the vehicle 1.

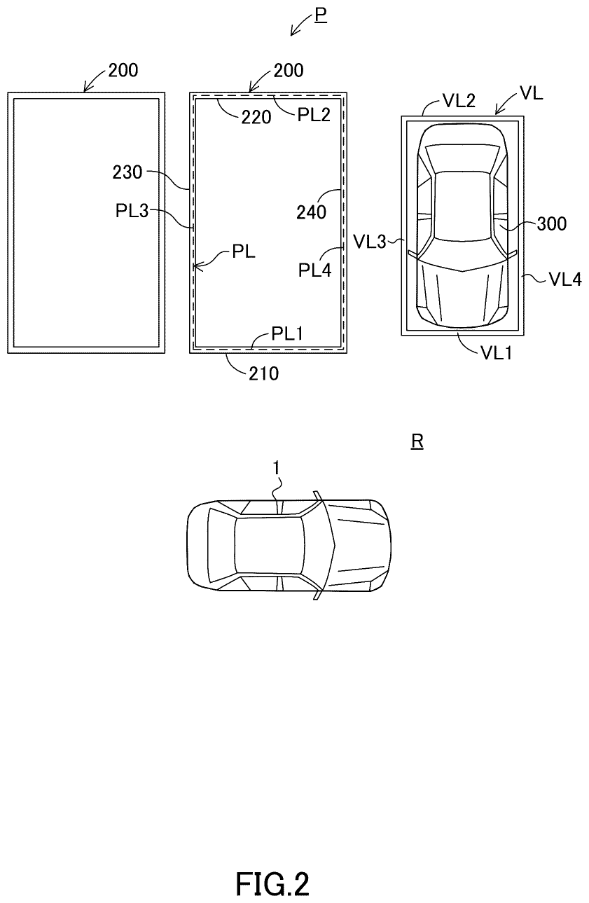

The parking space recognition module 11A recognizes parking spaces in a parking lot based on the image data on the periphery of the vehicle 1 captured by the camera sensor 41. FIG. 2 is a schematic view for illustrating examples of a partition line 200 drawn on a surface (for example, a paved surface) of a parking lot P. In FIG. 2, reference symbol 300 denotes a parked vehicle parked in the parking lot P, and reference symbol R denotes a passage R for travel of the vehicle 1 which has entered the parking lot P. The parking space recognition module 11A applies, to the image data captured by the camera sensor 41, image analysis processing such as edge detection, pattern matching, and feature point extraction, to thereby extract the partition lines 200 from the image data and to recognize parking spaces PL based on the extracted partition lines 200. The partition line 200 is a white line or the like drawn on a surface of the parking lot P in order to partition the parking space PL for parking one vehicle. It is only required to, for example, compare dimensions of a region defined by the extracted partition line 200 and standard parking space dimensions (width and depth) of a general public parking lot with each other to determine whether or not the partition line 200 partitions the parking space PL. In the present disclosure, “drawn” is a concept of display on the surface of the parking lot P through use of not only paint but also ropes or other means.

In FIG. 2, the partition line 200 is drawn as a solid line in a substantially rectangular frame shape on the road surface. In this case, the parking space recognition module 11A extracts, of a pair of partition lines 210 and 220 extending substantially in parallel with an extension direction of the passage R, the partition line 210 on the passage R side as a front-side boundary line PL1 and the partition line 220 apart more from the passage R than the partition line 210 as a rear-side boundary line PL2. Moreover, the parking space recognition module 11A extracts, of a pair of partition lines 230 and 240 crossing the partition lines 210 and 220 at a substantially right angle, the partition line 230 on the left side as viewed from the passage R side as a left-side boundary line PL3 and the partition line 240 on the right side as a right-side boundary line PL4. The parking space recognition module 11A acquires position information (for example, coordinates in an xy plane coordinate system having the position of the vehicle 1 as the origin) on those extracted boundary lines PL1 to PL4 with respect to the vehicle 1. Moreover, the parking space recognition module 11A transmits the acquired position information on the boundary lines PL1 to PL4 to the parking row determination module 13 at a predetermined cycle.

The partition line 200 is not limited to the solid line having the rectangular shape of FIG. 2, and may be two parallel straight lines or the like. In the case of the two parallel straight lines, the parking space recognition module 11A is only required to extract, as the front-side boundary line PL1 and the rear-side boundary line PL2, virtual partition lines each of which connects end portions of the parallel straight lines to each other.

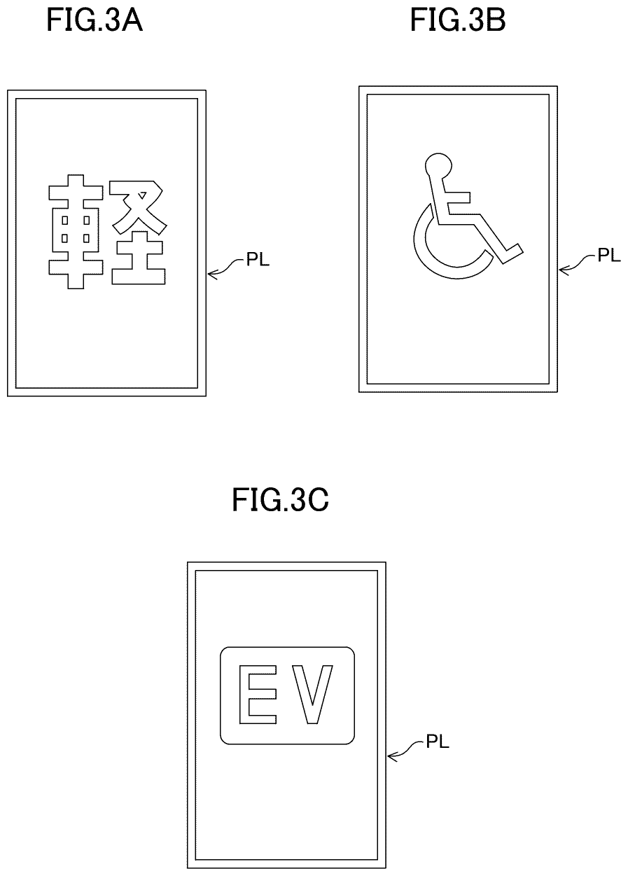

The specific parking space recognition module 11B recognizes whether or not the parking space PL recognized by the parking space recognition module 11A is a specific parking space PLS having a specific mark drawn on the surface (for example, a paved surface) in this parking space PL. Examples of the specific mark include a light automobile mark of FIG. 3A indicating a parking space dedicated for a light automobile, a wheelchair mark of FIG. 3B indicating a priority parking space for a disabled person, and an EV mark of FIG. 3C indicating a parking space dedicated for charging the EV. The specific mark is not limited to the examples of FIG. 3A to FIG. 3C, and may be other characters relating to the parking lot such as “P” and “GUEST.” The specific parking space recognition module 11B acquires the specific mark drawn on the surface of the parking space PL based on the image data on the periphery of the vehicle 1 captured by the camera sensor 41. It is only required to acquire the specific mark by applying, to the image data captured by the camera sensor 41, image analysis processing such as the edge extraction, the pattern matching, and the feature point extraction. When the specific parking space recognition module 11B acquires the specific mark in the parking space PL from the image data, the specific parking space recognition module 11B recognizes this parking space PL as a specific parking space PLS. The specific parking space recognition module 11B transmits a recognition result to the parking row determination module 13.

The parked vehicle recognition module 12 recognizes a vehicle contour line (hereinafter referred to as “parked vehicle contour line”) being a boundary between the parked vehicle 300 and the road surface based on the image data on the periphery of the vehicle 1 captured by the camera sensor 41. In FIG. 2, reference symbol VL denotes the parked vehicle contour line. The actual parked vehicle contour line VL is a complicated shape including side mirrors and the like, but the parked vehicle contour line VL is described as a minimum rectangular frame line which accommodates a vehicle body outer periphery of the parked vehicle 300.

The parked vehicle recognition module 12 first applies, to the image data captured by the camera sensor 41, image analysis processing such as the edge extraction, the pattern matching, and the feature point extraction, to thereby determine whether or not the parked vehicle 300 appears in the image data. Moreover, when the parked vehicle recognition module 12 determines that the parked vehicle 300 appears in the image data, the parked vehicle recognition module 12 specifies the minimum rectangular frame line which accommodates the parked vehicle 300 in the image data, and extracts the specified rectangular frame line as the parked vehicle contour line VL. The parked vehicle recognition module 12 extracts, as a front-side contour line LV1, a portion of the specified frame line that corresponds to a front end of the parked vehicle 300, extracts, as a rear-side contour line LV2, a portion thereof that corresponds to a rear end of the parked vehicle 300, extracts, as a left-side contour line LV3, a portion thereof that corresponds to a left end of the parked vehicle 300, and extracts, as a right-side contour line LV4, a portion thereof that corresponds to a right end of the parked vehicle 300. The parked vehicle recognition module 12 acquires position information on each of those extracted contour lines LV1 to LV4 with respect to the vehicle 1 (for example, coordinates in the xy plane coordinate system having the position of the vehicle 1 as the origin), and transmits the acquired position information to the parking row determination module 13 at a predetermined cycle.

The parking row determination module 13 determines whether or not the parking spaces PL and/or the parked vehicle contour lines VL form a continuous parking row based on the position information on the parking spaces PL transmitted from the parking space recognition module 11A and the position information on the parked vehicle contour lines VL transmitted from the parked vehicle recognition module 12. In the following description, a length direction of the parking space PL and the parked vehicle contour line VL is defined as “longitudinal direction,” and a direction substantially orthogonal to this length direction is defined as “lateral direction.” Moreover, an example in which the parking spaces PL and/or the parked vehicle contour lines VL are adjacent to each other in the lateral direction is described below, but similar processing is performed even in a case in which the parking spaces PL and/or the parked vehicle contour lines VL are adjacent to each other in the longitudinal direction, and hence description thereof is omitted.

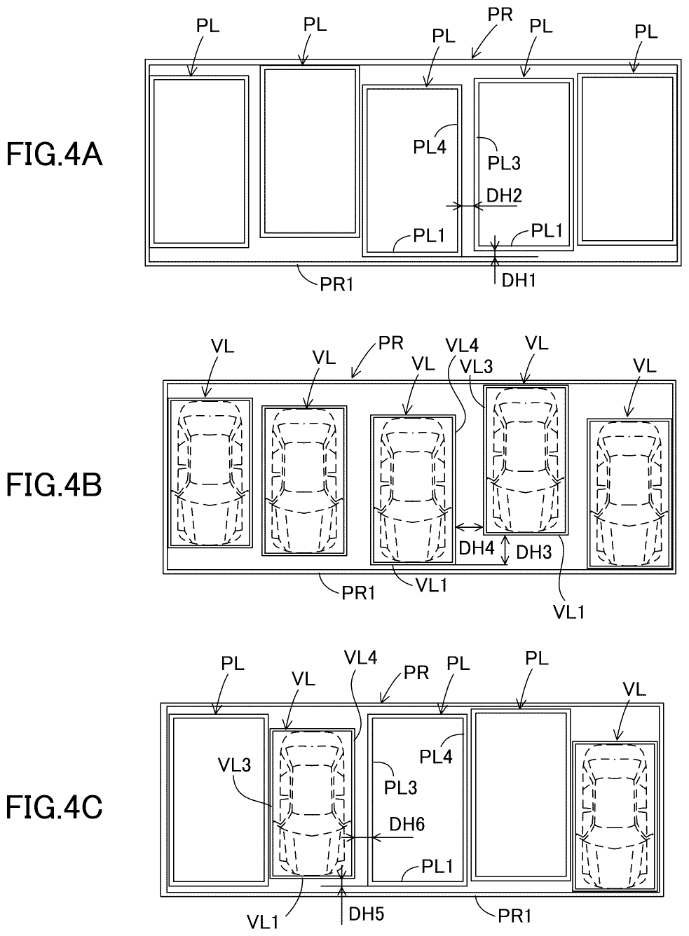

When the parking spaces PL adjacent to each other are acquired from the image data as illustrated in FIG. 4A, the parking row determination module 13 calculates a separation distance DH1 between the front-side boundary lines PL1 thereof in the longitudinal direction, and determines whether or not the separation distance DH1 satisfies a first condition that the separation distance DH1 is equal to or shorter than a predetermined first threshold value. The determination for the first condition may be made based on a separation distance between the rear-side boundary lines PL2. Moreover, the parking row determination module 13 calculates a separation distance DH2 between the left and right boundary lines PL3 and PL4 of the parking spaces PL adjacent to each other in the lateral direction, and determines whether or not the separation distance DH2 satisfies a second condition that the separation distance DH2 is equal to or shorter than a predetermined second threshold value. The first threshold value and the second threshold value are not particularly limited, and are only required to be set by considering standard numerical values of a general public parking lot as references. The parking row determination module 13 considers that those parking spaces PL adjacent to each other are continuous in the lateral direction when both of the first condition and the second condition are satisfied.

When the parked vehicle contour lines VL adjacent to each other are acquired from the image data as illustrated in FIG. 4B, the parking row determination module 13 calculates a separation distance DH3 between the front-side contour lines VL1 thereof in the longitudinal direction, and determines whether or not the separation distance DH3 satisfies a third condition that the separation distance DH3 is equal to or shorter than a predetermined third threshold value. The determination for the third condition may be made based on a separation distance between the rear-side contour lines VL2. Moreover, the parking row determination module 13 calculates a separation distance DH4 between the left and right contour lines VL3 and VL4 of the parked vehicle contour lines VL adjacent to each other in the lateral direction, and determines whether or not the separation distance DH4 satisfies a fourth condition that the separation distance DH4 is equal to or shorter than a predetermined fourth threshold value. The third threshold value and the fourth threshold value are not particularly limited, but it is preferred that at least the fourth threshold value be set to a value larger than the second threshold value. The parking row determination module 13 considers that those vehicle contour lines VL adjacent to each other are continuous in the lateral direction when both of the third condition and the fourth condition are satisfied.

When the parking spaces PL and the parked vehicle contour lines VL are acquired from the image data as illustrated in FIG. 4C, the parking row determination module 13 calculates a separation distance DH5 in the longitudinal direction between the front-side boundary line PL1 of the parking space PL and the front-side contour line VL1 of the parked vehicle contour line VL, and determines whether or not the separation distance DH5 satisfies a fifth condition that the separation distance DH5 is equal to or shorter than a predetermined fifth threshold value. The determination for the fifth condition may be made based on a separation distance between the rear-side boundary line PL2 and the rear-side contour line VL2. Moreover, the parking row determination module 13 calculates a separation distance DH6 in the lateral direction between one of the left and right boundary lines PL3 and PL4 of the parking space PL and a corresponding one of the left and right contour lines VL3 and VL4 of the parked vehicle contour line VL, and determines whether or not the separation distance DH6 satisfies a sixth condition that the separation distance DH6 is equal to or shorter than a predetermined sixth threshold value. The fifth threshold value and the sixth threshold value are not particularly limited, but it is preferred that at least the sixth threshold value be set to a value larger than the second threshold value and smaller than the fourth threshold value. The parking row determination module 13 considers that those parking space PL and parked vehicle contour line VL adjacent to each other are continuous in the lateral direction when both of the fifth condition and the sixth condition are satisfied.

When the number of continuous parking spaces PL, the number of continuous parked vehicle contour lines VL, or the number of continuous parking spaces PL and parked vehicle contour lines VL in any sequence is equal to or larger than a predetermined first threshold value number X_₁ (for example, 5), the parking row determination module 13 determines the minimum rectangular frame PR which accommodates a set thereof as the parking row. As described above, it is possible to effectively prevent such a situation that a road sign such as a stop line or a pedestrian crossing drawn on a road surface of a general road or another vehicle stopped at a traffic light or the like in the periphery of the vehicle 1 is erroneously determined as a parking row by determining, when the number of continuous parking spaces PL, the number of continuous parked vehicle contour lines VL, or the number of continuous parking spaces PL and parked vehicle contour lines VL is equal to or larger than the first threshold value number X_₁, the set thereof as the parking row.

In this case, when the parking row determination is made always based on the first threshold value number X_₁, a correct operation rate of driving force suppression control described later may be reduced. In order to increase the correct operation rate of the driving force suppression control, it is desired that, when at least one or more parking spaces PL satisfy a specific condition even when the number of continuous parking spaces PL and/or parked vehicle contour lines VL is less than the first threshold value number X_₁, the set of the parking spaces PL and the parked vehicle contour lines VL be determined as the parking row, to thereby effectively operate the driving force suppression control. Examples of the parking space PL which satisfies the specific condition include the specific parking space PLS in which the above-mentioned specific mark is drawn. The specific mark is easily recognized by the camera sensor 41, and is easily distinguished from paint (for example, the white line and a zebra zone) drawn on the road surface of the general road, and hence the specific mark is less liable to cause erroneous recognition.

When the specific parking space recognition module 11B determines at least one or more parking spaces PL as the specific parking space PLS, even when the number of continuous parking spaces PL and/or parked vehicle contour lines VL is smaller than the first threshold value number X_₁, but equal to or larger than a second threshold value number X_₂ (a number smaller than the first threshold value number X_₁, such as 2 or 3), the parking row determination module 13 determines that the set of the parking spaces PL and/or the parked vehicle contour lines VL including this specific parking space PLS is a parking row. That is, the condition for determining the parking row is relaxed when the specific parking space PLS which is less liable to cause the erroneous recognition exists. As a result, the correct operation rate of the driving force suppression control described later can effectively be increased.

When the parking row determination module 13 determines the continuous parking spaces PL and/or parked vehicle contour lines VL as the parking row, the parking row determination module 13 extracts, from the image data, the rectangular frame PR which defines the parking row, and acquires position information (for example, coordinates in the xy plane coordinate system having the position of the vehicle 1 as the origin) on each of straight lines PR1 to PR4 forming the extracted rectangular frame PR with respect to the vehicle 1. Moreover, the parking row determination module 13 transmits the acquired position information on each of the straight lines PR1 to PR4 to the intra-parking lot determination module 16 at a predetermined cycle. The straight line PR1 of the rectangular frame PR facing the passage R is referred to as “front-side parking row line.” Moreover, the rectangular frame PR is referred to as “parking row.”

The travel trajectory prediction module 15 calculates a predicted travel trajectory of the vehicle 1 based on the travel state of the vehicle 1 acquired by the vehicle state acquisition device 30. The predicted travel trajectory is a trajectory on which the vehicle is predicted to travel when the current travel state of the vehicle 1 is maintained. The predicted travel trajectory can be calculated based on, for example, the vehicle speed V acquired by the vehicle speed sensor 31, the steering angle acquired by the steering angle sensor 34, and the like. The travel trajectory prediction module 15 transmits, at a predetermined cycle, the calculated predicted travel trajectory to the intra-parking lot determination module 16.

The intra-parking lot determination module 16 determines whether or not the vehicle 1 exists in the parking lot P, that is, whether or not the vehicle 1 is traveling in the parking lot P based on the position information on the parking row PR with respect to the vehicle 1 transmitted from the parking row determination module 13 and the predicted travel trajectory of the vehicle 1 transmitted from the travel trajectory prediction module 15. The intra-parking lot determination module 16 first determines whether or not the predicted travel trajectory of the vehicle 1 crosses the front-side parking row line PR1 of the parking row PR. When the intra-parking lot determination module 16 determines that the predicted travel trajectory crosses the front-side parking row line PR1, the intra-parking lot determination module 16 calculates a predicted arrival time TA taken by the vehicle 1 to travel from a current position to arrival at an intersection position at which the predicted travel trajectory and the front-side parking row line PR1 intersect with each other. It is only required to obtain the predicted arrival time TA by, for example, dividing a distance D along the predicted travel trajectory from the current position of the vehicle 1 to the intersection position by the current vehicle speed V of the vehicle 1 (TA=D/V). The intra-parking lot determination module 16 determines that the vehicle 1 exists in the parking lot P (is traveling in the parking lot P) when the predicted arrival time TA is equal to or shorter than a predetermined time (for example, several seconds), and sets an intra-parking lot flag FP to ON (FP=1). Meanwhile, the intra-parking lot determination module 16 determines that the vehicle 1 does not exist in the parking lot P (or is not traveling in the parking lot P) when the predicted arrival time TA exceeds the predetermined time, and sets the intra-parking lot flag FP to OFF (FP=0).

The erroneous operation determination module 17 determines whether or not the driver of the vehicle 1 has executed an accelerator erroneous operation being erroneous depression of an accelerator pedal. Specifically, the erroneous operation determination module 17 determines that the accelerator erroneous operation has been executed when all of a first condition that the vehicle speed V of the vehicle 1 is lower than a predetermined vehicle speed threshold value V_{Min}, a second condition that an accelerator pedal operation amount (accelerator operation amount) AP is equal to or larger than a predetermined operation amount threshold value AP_{Max}, a third condition that an accelerator pedal operation speed APV is equal to or higher than a predetermined operation speed threshold value APV_{Max}, a fourth condition that a brake operation is not executed, and a fifth condition that the direction indicator is not operated are satisfied, and hence sets an erroneous operation flag FA to ON (FA=1). Meanwhile, when at least one of the first determination condition to the fifth determination condition is not satisfied, the erroneous operation determination module 17 determines that the accelerator erroneous operation has not been executed by the driver, and hence sets the erroneous operation flag FA to OFF (FA=0). The conditions for determining the accelerator erroneous operation may be conditions obtained by omitting any of the first to fifth determination conditions, or by further adding another condition.

When the intra-parking lot determination module 16 determines that the vehicle 1 exists in the parking lot P (FP=1), and the erroneous operation determination module 17 determines that the accelerator erroneous operation has been executed by the driver (FA=1), the driving force suppression control module 18 executes the driving force suppression control of controlling the operation of the drive device 20 such that an actual acceleration GA of the vehicle 1 is equal to or lower than a predetermined limit acceleration G_{Lim}. A sudden acceleration of the vehicle 1 not intended by the driver can effectively be suppressed by executing the driving force suppression control of suppressing the actual acceleration GA of the vehicle 1 to an acceleration equal to or lower than the limit acceleration G_{Lim} when the driver has executed the accelerator erroneous operation in this manner. Moreover, it is possible to effectively prevent an unnecessary operation of the driving force suppression control on the general road and the like by setting, as the execution condition for the driving force suppression control, the determination which is made by the intra-parking lot determination module 16, and indicates that the vehicle 1 exists in the parking lot P. The driving force suppression control module 18 finishes the driving force suppression control (releases the limit acceleration G_{Lim}) when the accelerator operation amount AP decreases to an operation amount equal to or smaller than a predetermined finish threshold value APE after the driving force suppression control is started.

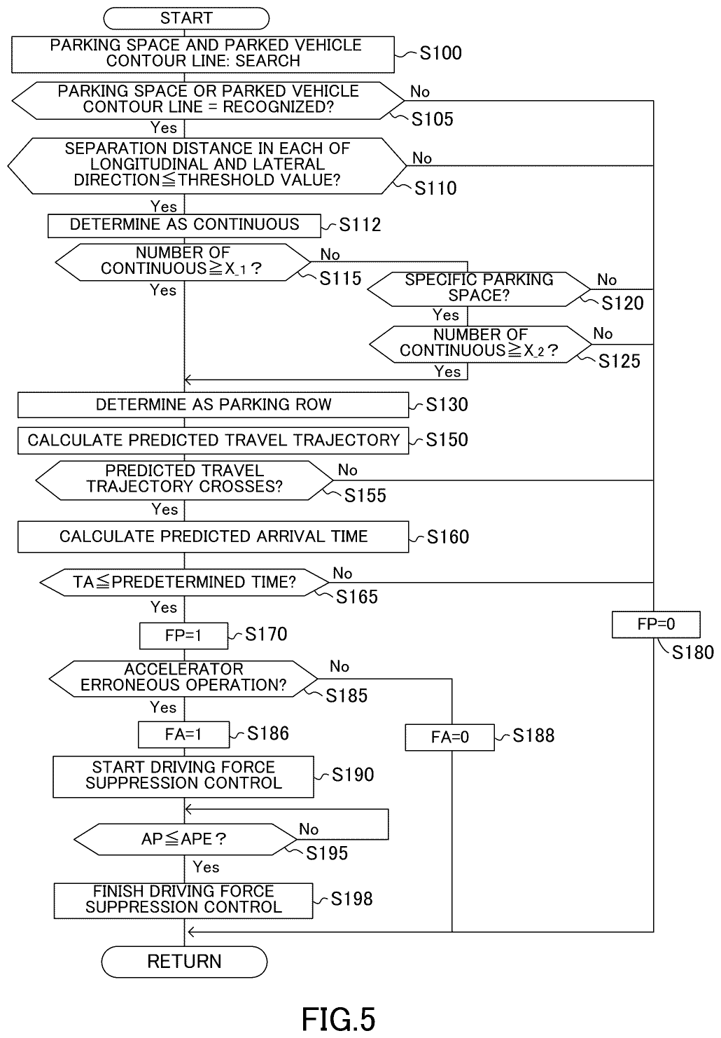

With reference to a flowchart of FIG. 5, description is now given of a routine of intra-parking lot determination processing, accelerator erroneous operation determination processing, and processing of the driving force suppression control by the ECU 10. When an ignition switch or a start button of the vehicle 1 is operated to ON, the ECU 10 repeatedly executes the routine of FIG. 5 at a predetermined cycle. The ECU 10 may be configured to execute the routine of FIG. 5 when the vehicle speed V of the vehicle 1 is equal to or lower than a predetermined speed threshold value.

In Step S100, the ECU 10 searches for parking spaces PL and parked vehicle contour lines VL in the periphery of the vehicle 1 based on the image data captured by the camera sensor 41. After that, in Step S105, the ECU 10 determines whether or not at least one of the parking space PL or the parked vehicle contour line VL has successfully been recognized from the image data. When a determination result is affirmative (Yes), the ECU 10 advances the process to Step S110. Meanwhile, when the determination result is negative (No), the ECU 10 advances the process to Step S180 and sets the intra-parking lot flag FP to OFF (FP=0). After that, the ECU 10 returns from this routine.

In Step S110, the ECU 10 determines whether or not the condition that the separation distance between the parking spaces PL, between the parked vehicle contour lines VL, or between the parking space PL and the parked vehicle contour line VL adjacent to each other in each of the longitudinal direction and the lateral direction is shorter than the predetermined threshold value is satisfied. When the condition is satisfied (Yes), the ECU 10 advances the process to Step S112 to determine that the parking space PL and/or the parked vehicle contour line VL is continuous to a corresponding one of the adjacent parking space PL and parked vehicle contour line VL, and advances the process to Step S115. Meanwhile, when the condition is not satisfied (No) in the determination of Step S110, the ECU 10 advances the process to Step S180. After that, the ECU 10 sets the intra-parking lot flag FP to OFF (FP=0), and returns from this routine.

In Step S115, the ECU 10 determines whether or not the condition that the number of continuous parking spaces PL, the number of continuous parked vehicle contour lines VL, or the number of continuous parking spaces PL and parked vehicle contour lines VL is equal to or larger than the first threshold value number X_₁ is satisfied. When the condition is satisfied (Yes), the ECU 10 advances the process to Step S130 to determine the parking spaces PL and/or parked vehicle contour lines VL as a parking row. After that, the ECU 10 acquires the position information on the parking row PR, and advances the process to Step S150. Meanwhile, when the condition is not satisfied (No) in the determination of Step S115, the ECU 10 advances the process to Step S120.

In Step S120, the ECU 10 determines whether or not at least one or more specific parking spaces PLS having a drawn specific mark exist in the parking spaces PL acquired in Step S100. When at least one or more specific parking spaces PLS exist (Yes), the ECU 10 advances the process to Step S125. Meanwhile, when a specific parking space PLS does not exist (No), the ECU 10 advances the process to Step S180. After that, the ECU 10 sets the intra-parking lot flag FP to OFF (FP=0), and returns from this routine.

In Step S125, the ECU 10 determines whether or not the condition that the number of continuous parking spaces PL including the at least one or more specific parking spaces PLS or the number of continuous parking spaces PL and parked vehicle contour lines VL including the at least one or more specific parking spaces PLS is equal to or larger than the second threshold value number X_₂ is satisfied. When the condition is satisfied (Yes), the ECU 10 advances the process to Step S130 to determine the parking spaces PL or the parking spaces PL and the parked vehicle contour lines VL as a parking row. After that, the ECU 10 acquires the position information on the parking row PR, and advances the process to Step S150. Meanwhile, when the condition is not satisfied (No) in the determination of Step S125, the ECU 10 advances the process to Step S180. After that, the ECU 10 sets the intra-parking lot flag FP to OFF (FP=0), and returns from this routine.

In Step S150, the ECU 10 calculates the predicted travel trajectory TP of the vehicle 1. After that, in Step S155, the ECU 10 determines whether or not the calculated predicted travel trajectory TP intersects with the front-side parking row line PR1 of the parking row PR. When the intersection occurs (Yes), the driving force ECU 10 advances the process to Step S160. Meanwhile, when the intersection does not occur (No), the ECU 10 advances the process to Step S180. After that, the ECU 10 sets the intra-parking lot flag FP to OFF (FP=0), and returns from this routine.

In Step S160, the ECU 10 calculates the predicted arrival time TA taken by the vehicle 1 to travel from the current position to arrival at the intersection position at which the predicted travel trajectory and the front-side parking row line PR1 intersect with each other. After that, in Step S165, the ECU 10 determines whether or not the predicted arrival time TA is equal to or shorter than the predetermined time. When the predicted arrival time TA is equal to or shorter than the predetermined time (Yes), the ECU 10 advances the process to Step S170. After that, the ECU 10 determines that the vehicle 1 exists in a parking lot P, that is, sets the intra-parking lot flag FP to ON (FP=1). Meanwhile, when the predicted arrival time TA is not equal to or shorter than the predetermined time (No), the ECU 10 advances the process to Step S180. After that, the ECU 10 sets the intra-parking lot flag FP to OFF (FP=0), and returns from this routine.

The ECU 10 sets the intra-parking lot flag FP to ON (FP=1) in the processing step of Step S170, and then advances the process to Step S185. In Step S185, the ECU 10 determines whether or not the driver has executed the accelerator erroneous operation. When all of the first to fifth determination conditions are satisfied (Yes), the ECU 10 determines that the driver has executed the accelerator erroneous operation. After that, the ECU 10 advances the process to Step S186, and sets the erroneous operation flag FA to ON (FA=1). Meanwhile, at least one of the first to fifth determination conditions is not satisfied (No), the ECU 10 determines that the driver has not executed the accelerator erroneous operation. After that, the ECU 10 advances the process to Step S188 to set the erroneous operation flag FA to OFF (FA=0), and then returns from this routine.

The ECU 10 sets the erroneous operation flag FA to ON (FA=1) in the processing step of Step S186, and then advances the process to Step S190. In Step S190, the ECU 10 starts the driving force suppression control. After that, in Step S195, the ECU 10 determines whether or not the accelerator operation amount AP has decreased to a value equal to or smaller than the finish threshold value APE. When the accelerator operation amount AP has not decreased to a value equal to or smaller than the finish threshold value APE (No), the ECU 10 repeats the determination of Step S195. Meanwhile, when the accelerator pedal operation amount AP has decreased to a value equal to or smaller than the finish threshold value APE (Yes), the ECU 10 advances the process to Step S198. After that, the ECU 10 finishes the driving force suppression control, and returns from this routine.

The parking lot determination device, the control device for a vehicle, and the parking lot determination method according to the at least one embodiment have been described, but the present disclosure is not limited to the above-mentioned at least one embodiment, and various modifications are possible as long as modifications do not depart from the object of the present disclosure.

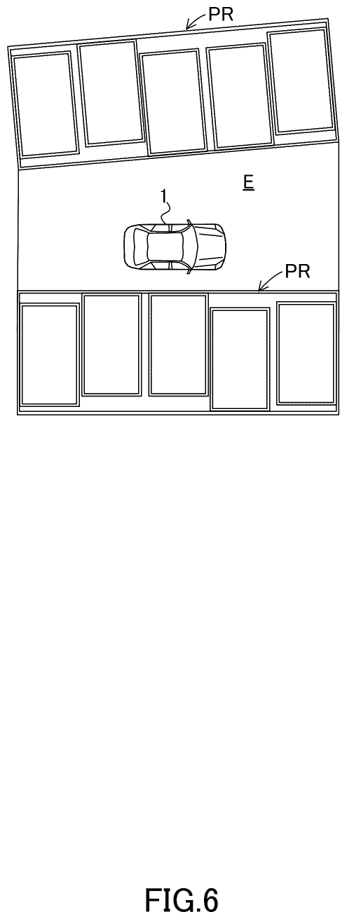

For example, as illustrated in FIG. 6, when the parking row determination module 13 acquires parking rows PR facing across the vehicle 1, and the vehicle 1 is positioned in a region E between those parking rows PR, the intra-parking lot determination module 16 may determine that the vehicle 1 exists in the parking lot P. Also in this case, when a specific parking space PLS is recognized in at least one of the opposing parking rows PR, it is only required to relax the determination condition for the parking row PR, that is, to use the second threshold value number X_₂ to make the parking row determination.

What is claimed is:

1. A parking lot determination device for recognizing, based on image data acquired by capturing a periphery of a vehicle, a parking space and/or a parked vehicle in the periphery of the vehicle, and determining that the vehicle is traveling in a parking lot when a determination condition that a predetermined number or more of adjacent parking spaces and/or adjacent parked vehicles are recognized is satisfied,
wherein the predetermined number to be used for the determination condition is reduced when a predetermined specific parking space is included in at least one or more parking spaces recognized based on the image data compared with the predetermined number to be used when the predetermined specific parking space is not included.

2. The parking lot determination device according to claim 1, wherein the predetermined specific parking space includes at least one of a first specific parking space indicating a parking space dedicated for a light automobile, a second specific parking space indicating a priority parking space for a disabled person, or a third specific parking space indicating a parking space dedicated for charging an electric vehicle.

3. A control device for a vehicle, the control device comprising the parking lot determination device of claim 1,
wherein the control device is configured to execute driving force suppression control of suppressing a driving force of the vehicle when the parking lot determination device determines that the vehicle is traveling in the parking lot, and an erroneous operation in which an accelerator to be depressed by an occupant of the vehicle to accelerate the vehicle is erroneously depressed by the occupant is detected.

4. A parking lot determination method, comprising:
recognizing, based on image data acquired by capturing a periphery of a vehicle, a parking space and/or a parked vehicle in the periphery of the vehicle;
determining that the vehicle is traveling in a parking lot when a determination condition that a predetermined number or more of adjacent parking spaces and/or adjacent parked vehicles are recognized is satisfied; and
reducing the predetermined number to be used for the determination condition when a predetermined specific parking space is included in at least one or more parking spaces recognized based on the image data compared with the predetermined number to be used when the predetermined specific parking space is not included.
